(19) United States
(12) Patent Application Publication
(10) Pub. No.: US 2010/0295818 A1
(43) Pub. Date: Nov. 25, 2010

(54) CAPACITIVE TOUCH PANEL

(75) Inventors: Jao-Ching Lin, Taipei City (TW); Lin Abel Chu, Taipei City (TW); Yao-Chung Kuo, Taipei City (TW)

Correspondence Address: DLA PIPER LLP (US ), 2000 UNIVERSITY AVENUE, EAST PALO ALTO, CA, 94303-2248, US

(73) Assignee: SENTELIC CORPORATION, Taipei City (TW)

(21) Appl. No.: 12/625,440

(22) Filed: Nov. 24, 2009

(30) Foreign Application Priority Data
May 25, 2009 (TW) 098209170

(51) Int. Cl. G06F 3/044

(52) U.S. Cl. 345/174

(57) ABSTRACT

A capacitive touch panel includes: a substrate having upper and lower surfaces and vias; a first patterned layer formed on the upper surface of the substrate and including first electrode units, each of the first electrode units being connected to a respective one of the vias and including interconnected first electrode pads that are aligned in a first direction; a first insulating layer disposed above and covering the first patterned layer; and a second patterned layer disposed above and formed on the first insulating layer and including second electrode units. Each of the second electrode units is connected to a respective one of the vias and includes interconnected second electrode pads that are aligned in a second direction transverse to the first direction.

### CROSS-REFERENCE TO RELATED APPLICATION

This application claims priority of Taiwanese Application No. 098209170, filed on May 25, 2009.

### BACKGROUND OF THE INVENTION

1. Field of the Invention

This invention relates to a capacitive touch panel, more particularly to a capacitive touch panel including a substrate and first and second patterned layers of electrode pads formed over the substrate.

2. Description of the Related Art

FIG. 1 illustrates a conventional capacitive touch panel disclosed in U.S. Pat. No. 6,188,391. The disclosure of U.S. Pat. No. 6,188,391 is incorporated herein by reference. The conventional capacitive touch panel includes: a substrate 20 having upper and lower surfaces 201, 202 and formed with first and second vias 203, 204; a patterned conductive layer 21 formed on the upper surface 201 of the substrate 20 and including a plurality of first electrode units, each of which has interconnected first electrode pads 211 aligned in a first direction and a plurality of second electrode units, each of which has second electrode pads 212 aligned in a second direction transverse to the first direction; an insulating layer 22 formed on the upper surface 201 of the substrate 20, covering the first and second electrode pads 211, 212, and formed with holes that are registered with the second electrode pads 212, respectively; a plurality of bridging lines 23 of carbon ink formed over the insulating layer 22, each of the bridging lines 23 being connected to a respective one of the second vias 204 and having segments that extend through corresponding ones of the holes in the insulating layer 22 to connect with the second electrode pads 212 of a respective one of the second electrode units; and a patterned trace layer 24 including conductive traces, each of which is connected to a respective one of the first and second electrode units through a corresponding one of the first and second vias 203, 204. The first and second electrode units cooperatively form an array of capacitive sensors for detecting a position of an object, such as a finger or a stylus, near or in contact with a planar surface (not sown) of the capacitive touch panel.

The aforementioned capacitive touch panel is disadvantageous in that it requires formation of the holes in the insulating layer 22, alignment of the holes with the second electrode pads 212, and formation of the bridging lines 23 (made of carbon ink) to connect the second electrode pads 212 (made of copper foil) of each second electrode unit. Such a configuration not only is complicated and increases manufacturing costs, but also can result in poor connection between each bridging line 23 and the respective second electrode pad unit, thereby resulting in overall unstable electrical properties for the capacitive touch panel.

### SUMMARY OF THE INVENTION

The object of the present invention is to provide a capacitive touch panel that can overcome the aforesaid drawbacks associated with the prior art.

According to this invention, there is provided a capacitive touch panel that comprises: a substrate having upper and lower surfaces and a plurality of vias extending through the upper and lower surfaces; a first patterned layer formed on the upper surface of the substrate and including a plurality of first electrode units, each of the first electrode units being connected to a respective one of the vias and including a plurality of interconnected first electrode pads that are aligned in a first direction; a first insulating layer disposed above and covering the first patterned layer; and a second patterned layer disposed above and formed on the first insulating layer and including a plurality of second electrode units. Each of the second electrode units is connected to a respective one of the vias and includes a plurality of interconnected second electrode pads that are aligned in a second direction crossing the first direction.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a fragmentary sectional view of a conventional capacitive touch panel;

FIG. 2 is a schematic top view of the first preferred embodiment of a capacitive touch panel according to this invention;

FIG. 3 is a schematic top view of the first preferred embodiment with a patterned layer and an insulating layer removed from the capacitive touch panel;

FIG. 4 is a schematic bottom view of the first preferred embodiment;

FIG. 5 is a fragmentary sectional view of the first preferred embodiment;

FIG. 6 is a fragmentary sectional view of the second preferred embodiment of a capacitive touch panel according to this invention;

FIG. 7 is a fragmentary sectional view of the third preferred embodiment of a capacitive touch panel according to this invention;

FIG. 8 is a schematic top view of the fourth preferred embodiment of a capacitive touch panel according to this invention;

FIG. 9 is a schematic top view of the fourth preferred embodiment with a patterned layer and an insulating layer removed from the capacitive touch panel; and

FIG. 10 is a schematic bottom view of the fourth preferred embodiment.

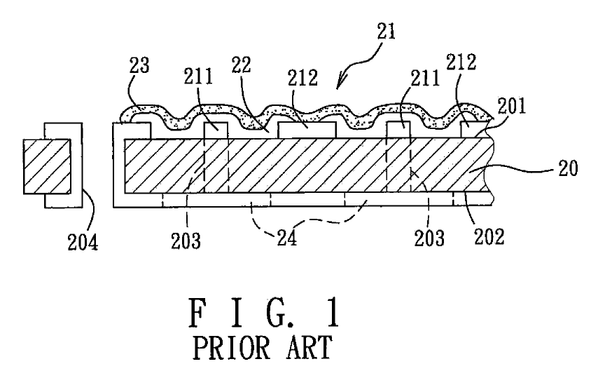

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

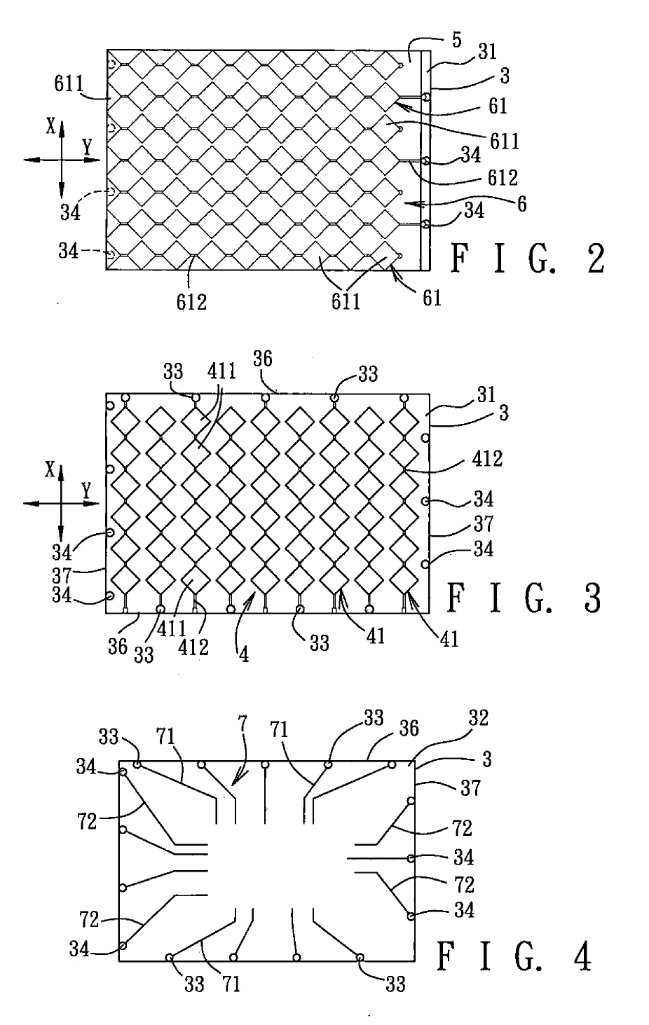

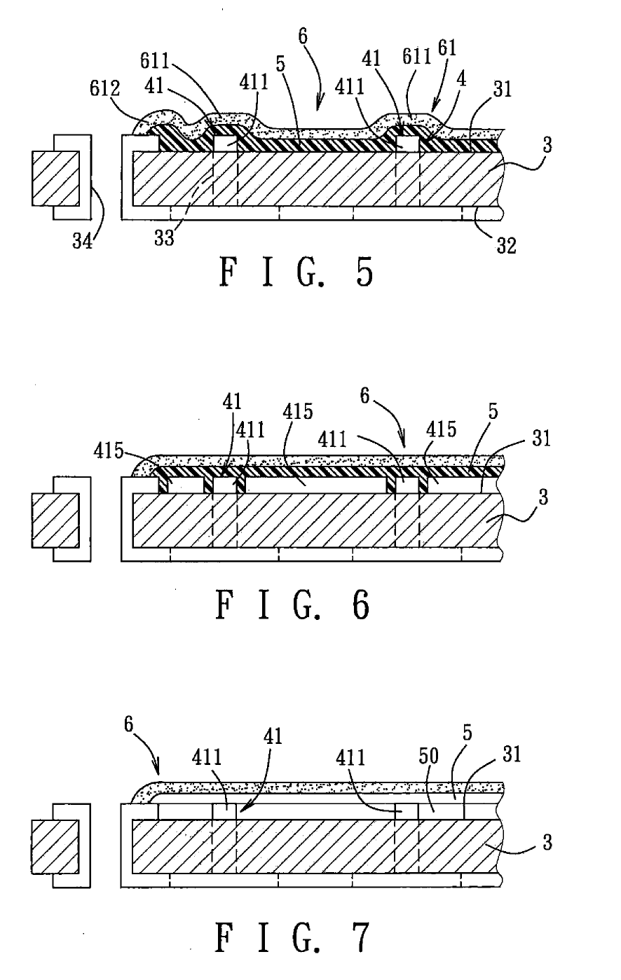

FIGS. 2 to 5 illustrate the first preferred embodiment of a capacitive touch panel according to this invention. The capacitive touch panel includes: a substrate 3 having upper and lower surfaces 31, 32 and a plurality of vias extending through the upper and lower surfaces 31, 32, the vias being divided into a group of first vias 33 and a group of second vias 34; a conductive first patterned layer 4 formed on the upper surface 31 of the substrate 3 (see FIGS. 3 and 5) and including a plurality of first electrode units 41, each of the first electrode units 41 being connected to a respective one of the first vias 33 and including a plurality of interconnected first electrode pads 411 that are aligned in a first direction (X); a first insulating layer 5 formed on the upper surface 31 of the substrate 3 and disposed above and covering the first patterned layer 4 (see FIGS. 2 and 5); a conductive second patterned layer 6 disposed above and formed on the first insulating layer 5 (see FIGS. 2 and 5) and including a plurality of second electrode units 61, each of the second electrode units 61 being connected to a respective one of the second vias 34 and including a plurality of interconnected second electrode pads 611 that are aligned in a second direction (Y) crossing the first direction (X) (in the preferred embodiment, the first and second directions (X, Y) are perpendicular to each other); a patterned trace layer 7 formed on the lower surface 32 of the substrate 3 (see FIG. 4) and including a plurality of first conductive traces 71 and a plurality of second conductive traces 72; and a protective layer (not shown) formed on the patterned trace layer 7. The first and second electrode units 41, 61 cooperatively form an array of capacitive sensors for detecting a position of an object, such as a finger or a stylus, near or in contact with a surface of the protective layer of the capacitive touch panel.

Each of the first and second conductive traces 71, 72 is connected to a respective one of the first and second vias 33, 34. Preferably, each of the first electrode units 41 further includes a plurality of first connecting lines 412 to interconnect the first electrode pads 411 of a respective one of the first electrode units 41 (see FIG. 3). Preferably, each of the second electrode units 6 further includes a plurality of second connecting lines 612 to interconnect the second electrode pads 611 of a respective one of the second electrode units 61 (see FIG. 2).

The substrate 3 further has two opposite first lateral edge portions 36 (see FIG. 3) and two opposite second lateral edge portions 37 transverse to the first lateral edge portions 36.

In this embodiment, the first vias 33 are formed at and evenly distributed along the first lateral edge portions 36 of the substrate 3 (see FIG. 4), and the second vias 34 are formed at and evenly distributed along the second lateral edge portions 37 of the substrate 3. It is noted that one of the second lateral edge portions 37 is not covered by the first insulating layer 5 so as to expose the second vias 34 at the right-hand side of the substrate 3 and to permit connection of the second vias 34 with the respective ones of the first connecting lines 612.

Preferably, the substrate 3 is a two-layer printed circuit board and the insulating layer 5 is made from a solder mask insulator.

Preferably, the first patterned layer 4 is made from copper clad, and the second patterned layer 6 is formed from printed conductive ink, such as silver ink, carbon ink, aluminum ink or silver-aluminum ink.

FIG. 6 illustrates the second preferred embodiment of a capacitive touch panel according to this invention. The second preferred embodiment differs from the previous embodiment in that the former further includes a plurality of dummy pads 415 formed on the upper surface 31 of the substrate 3 and disposed among the first electrode pads 411 of the first electrode units 41. The first insulating layer 5 also covers the dummy pads 415 (i.e., in addition to the first electrode pads 411).

FIG. 7 illustrates the third preferred embodiment of a capacitive touch panel according to this invention. The third preferred embodiment differs from the first preferred embodiment in that the former further includes a second insulating layer 50 formed on the upper surface 31 of the substrate 3. Each two adjacent ones of the first electrode units 41 are spaced apart from each other by a gap that is filled by the second insulating layer 50. The first insulating layer 5 covers the second insulating layer 50. The first insulating layer 5 and the second insulating layer 50 can be made from different materials.

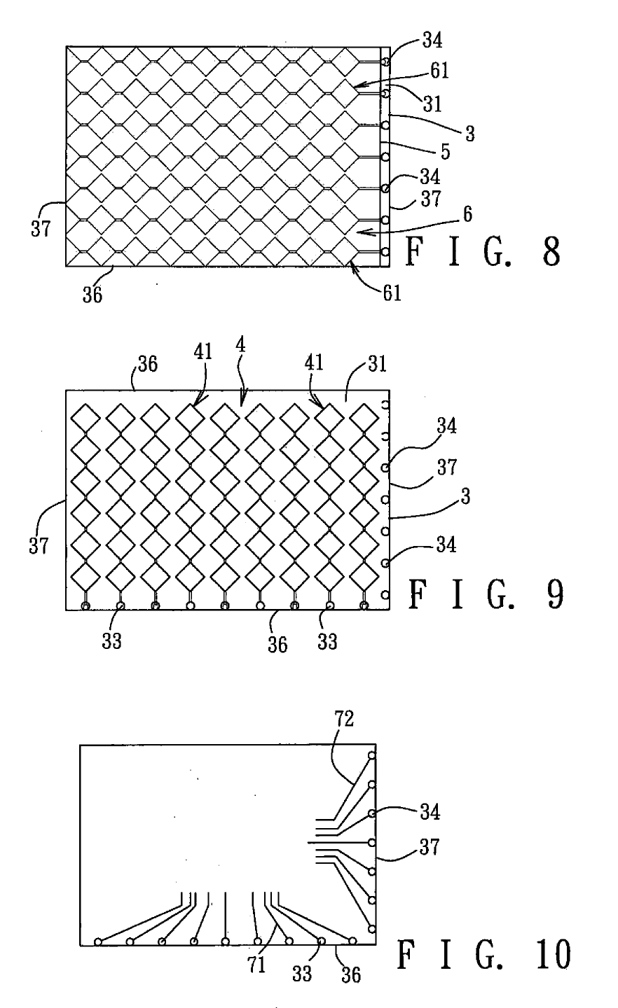

FIGS. 8 to 10 illustrate the fourth preferred embodiment of a capacitive touch panel according to this invention. The fourth preferred embodiment differs from the first preferred embodiment in that the first vias 33 are formed at and evenly distributed along one of the first lateral edge portions 36 of the substrate 3, and the second vias 34 are formed at and evenly distributed along one of the second lateral edge portions 37 of the substrate 3.

With the second patterned layer 6 being formed on the first insulating layer 5 of the capacitive touch panel of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A capacitive touch panel comprising:
a substrate having upper and lower surfaces and a plurality of vias extending through said upper and lower surfaces;
a first patterned layer formed on said upper surface of said substrate and including a plurality of first electrode units, each of said first electrode units being connected to a respective one of said vias and including a plurality of interconnected first electrode pads that are aligned in a first direction;
a first insulating layer disposed above and covering said first patterned layer; and
a second patterned layer disposed above and formed on said first insulating layer and including a plurality of second electrode units, each of said second electrode units being connected to a respective one of said vias and including a plurality of interconnected second electrode pads that are aligned in a second direction crossing said first direction.

2. The capacitive touch panel of claim 1, further comprising a patterned trace layer formed on said lower surface of said substrate and including a plurality of first conductive traces and a plurality of second conductive traces, each of said first and second conductive traces being connected to a respective one of said vias.

3. The capacitive touch panel of claim 1 further comprising a plurality of dummy pads formed on said upper surface of said substrate and disposed among said first electrode pads of said first electrode units, said first insulating layer covering said dummy pads.

4. The capacitive touch panel of claim 1, further comprising a second insulating layer, each two adjacent ones of said first electrode pad units being spaced apart from each other by a gap that is filled by said second insulating layer, said first insulating layer covering said second insulating layer.

5. The capacitive touch panel of claim 1, wherein said substrate further has a first lateral edge portion and a second lateral edge portion transverse to said first lateral edge portion, said vias being divided into a group of first vias and a group of second vias, said first vias being formed at said first lateral edge portion of said substrate, said second vias being formed at said second lateral edge portion of said substrate, said first electrode units being connected to said first vias, respectively, said second electrode units being connected to said second vias, respectively.

6. The capacitive touch panel of claim 1, wherein said substrate further has two opposite first lateral edge portions and two opposite second lateral edge portions transverse to said first lateral edge portions, said vias being divided into a group of first vias and a group of second vias, said first vias being formed at said first lateral edge portions of said substrate, said second vias being formed at said second lateral edge portions of said substrate, said first electrode units being connected to said first vias, respectively, said second electrode units being connected to said second vias, respectively.

7. The capacitive touch panel of claim 1, wherein said substrate is a two-layer printed circuit board.

8. The capacitive touch panel of claim 1, wherein said insulating layer is made from a solder mask insulator.

9. The capacitive touch panel of claim 1, wherein said second patterned layer is formed from printed conductive ink.

10. The capacitive touch panel of claim 1, wherein each of said first electrode units further includes a plurality of first connecting lines to interconnect said first electrode pads of a respective one of said first electrode units, each of said second electrode units further including a plurality of second connecting lines to interconnect said second electrode pads of a respective one of said second electrode units.
